(19) United States
(12) Patent Application Publication
(10) Pub. No.: US 2007/0284919 A1
(43) Pub. Date: Dec. 13, 2007

(54) Vehicle Seat With Pivotable Flap

(75) Inventors: Walter Woth, Nonnweiler (DE); Eckhard Spies, Enkenbach-Alsenborn (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GMBH & CO. KG, Kaiserslautern (DE)

(21) Appl. No.: 11/782,380

(22) Filed: Jul. 24, 2007

Related U.S. Application Data
(63) Continuation of application No. PCT/EP2006/000152, filed on Jan. 11, 2006.

(30) Foreign Application Priority Data
Jan. 25, 2005 (DE) 10 2005 003 288.5

(51) Int. Cl. B60N 2/20

(52) U.S. Cl. 297/113

(57) ABSTRACT

In a vehicle seat (1), in particular a motor vehicle seat, having a seat structure (3), a backrest structure (5) and a flap structure (10) that can be releasably locked with the backrest structure (5) in a use position and that can be pivoted relative to the backrest structure (5) from the use position into a non-use position, the flap structure (10) can be locked with the backrest structure (5) by way of a rotating-sliding latch unit (20) which has a latch pin (22) that is extended in the use position and remains retracted in the non-use position.

### CROSS-REFERENCE TO RELATED APPLICATION

The present application is a continuation of International Application PCT/EP2006/000152, which was filed Jan. 11, 2006. The entire disclosure of PCT/EP2006/000152 is incorporated herein by reference.

### BACKGROUND OF THE INVENTION

The present invention relates to a vehicle seat, in particular a motor vehicle seat, having a seat structure, a backrest structure and a flap structure that can be releasably locked with the backrest structure in a use position, and that can be pivoted relative to the backrest structure from the use position into a non-use position.

In known vehicle seats of the type described immediately above, which are part of a divided rear seat installation, a latch, bracket or hook on the backrest structure and/or on the flap structure is freely accessible in the non-use position, thus exposing passengers to the risk of injuries.

### BRIEF SUMMARY OF SOME ASPECTS OF EXEMPLARY EMBODIMENT

One aspect of the present invention is the provision of improvements to a vehicle seat of the type mentioned above. In accordance with one aspect of the present invention, a vehicle seat, in particular a motor vehicle seat, has a seat structure, a backrest structure, a flap structure adapted for being pivoted relative to the backrest structure from a use position to a non-use position, and a rotating-sliding latch unit for releasably locking the flap structure to the backrest structure in the use position. The rotating-sliding latch unit has a latch pin that is extended in the use position and remains retracted in the non-use position.

Because the flap structure can be locked with the backrest structure by way of a rotating-sliding latch unit disclosed in DE 199 53 686 C1, which has a latch pin that is extended in the use position and remains retracted in the non-use position, the latch pin is prevented from protruding in the non-use position, thus eliminating or at least reducing the risk of injury. The backrest is preferably pivotable relative to the seat structure. However, the invention can also be used for locking two pivotable backrest structures with one another or for locking a pivotable flap structure with a fixed backrest structure or with the vehicle structure.

In order to keep the flap structure locked in the use position even in the event of the flap structure and the backrest structure being laterally forced apart in the event of misuse or a crash situation, the latch pin has at least one axially acting securing element, for example two radially opposed, radially projecting securing lugs or a collar or other flange. When locking occurs, each such securing lug passes through a recess of the latch opening and—because of the screw-like movement—engages behind that part of the edge of the latch opening that is adjacent to the recess, whereby additional positive attachment is achieved. The same also applies analogously to a collar, which preferably engages behind the latch.

The latch pin of the rotating-sliding latch unit extends preferably under spring loading and retracts when a trigger sleeve is turned, so that the non-actuated rotating-sliding latch unit performs the locking function. In a preferred embodiment, in order to maintain the rotating-sliding latch unit in an actuated and unlocked state, a locking lever may be provided which—in particular through cooperation with a stop lug on the trigger sleeve—blocks the rotated trigger sleeve and maintains the latch pin in a retracted position. For this purpose, when the flap structure is unlocked, the spring-loaded locking lever comes to bear against the back of the stop lug of the rotating trigger sleeve and then comes into positive engagement behind the stop lug. When the flap structure returns to the use position, the locking lever preferably swings (e.g., pivots) upward, in particular by contacting a bearing plate, and releases the trigger sleeve, so that the latch pin is again extended. To achieve high mobility of the locking lever, for example also in order to pass the bearing plate without hindrance when leaving the use position, the locking lever is preferably attached to a pivotably hinged guide arm.

In another preferred embodiment, a pulling means is attached with one end to the trigger sleeve and with its other end to the structure located opposite the rotating-sliding latch unit. In this case, the latch pin, which is for example locked by way of a pawl, is not yet retracted after unlocking. Only when the flap structure is pivoted forward does the pulling means—acting via a suitable deflection—rotate the trigger sleeve, thereby retracting the latch pin.

Other aspects and advantages of the present invention will become apparent from the following.

### BRIEF DESCRIPTION OF THE DRAWINGS

The invention is described below in more detail with reference to two exemplary embodiments illustrated in the drawings, in which:

FIG. 1 is a perspective view of the first exemplary embodiment without upholstery, with the flap in the non-use position.

FIG. 2 is a perspective partial view of the first exemplary embodiment, with the flap in the use position,

FIG. 3 is a lateral view of the unlocked flap structure, with the flap still in the use position,

FIG. 4 is a latch pin with pressure spring and ball bearings,

FIG. 5 is a rotating-sliding latch unit,

FIG. 6 is a perspective, partially sectional view of the second exemplary embodiment, with the flap in the non-use position, and

FIG. 7 is an incomplete representation of the flap structure of the second exemplary embodiment, including a bearing plate and a rear view of the rotating-sliding latch unit assigned to the backrest structure.

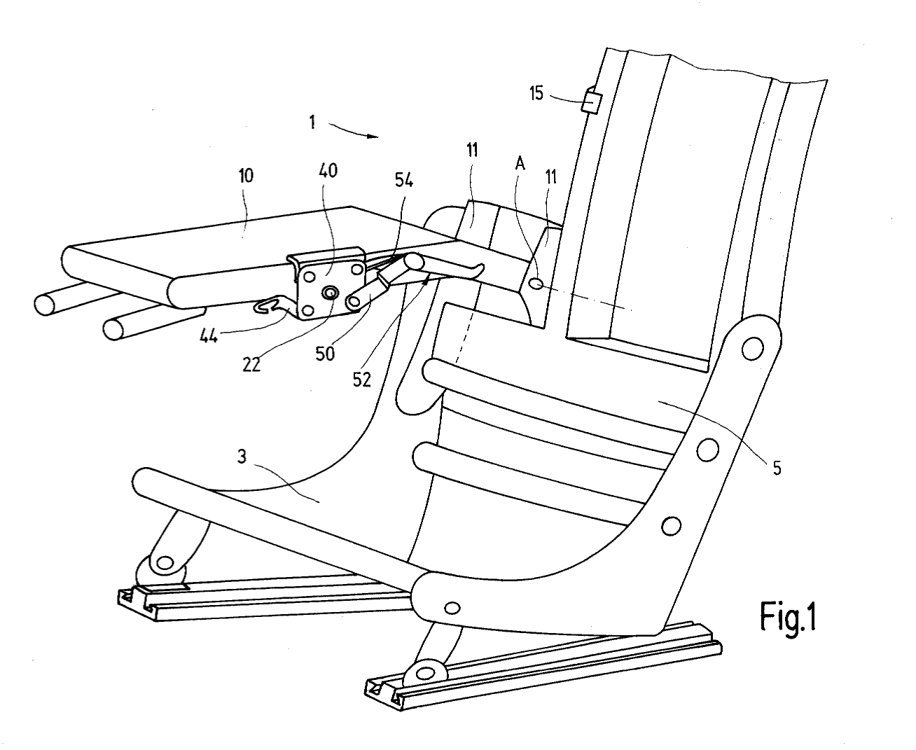

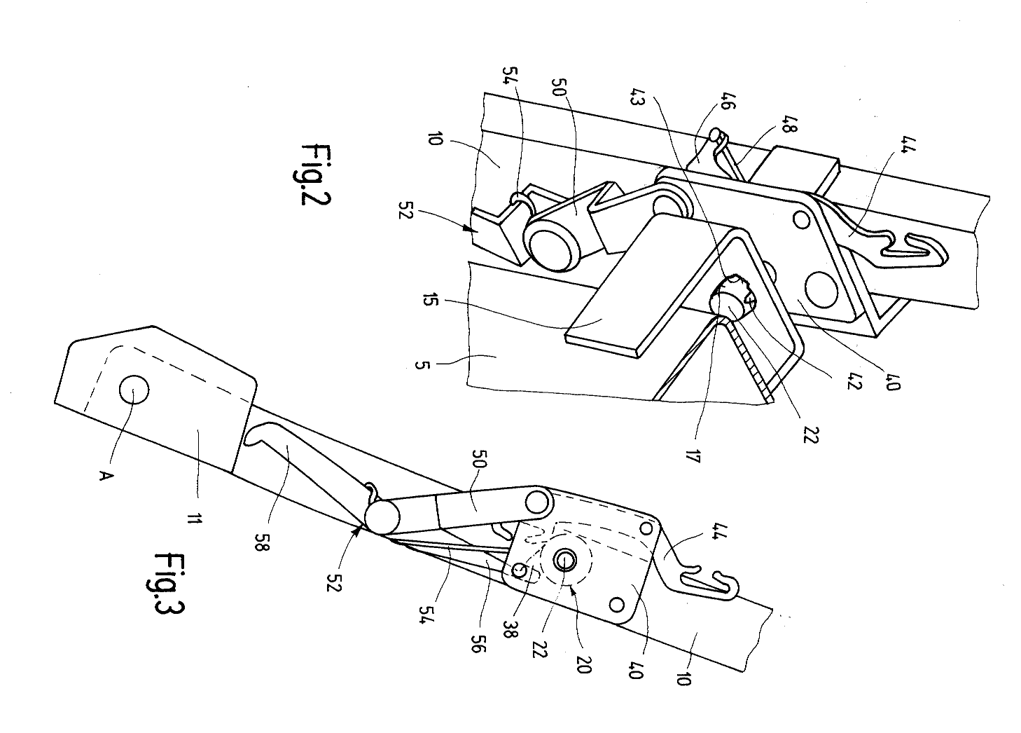

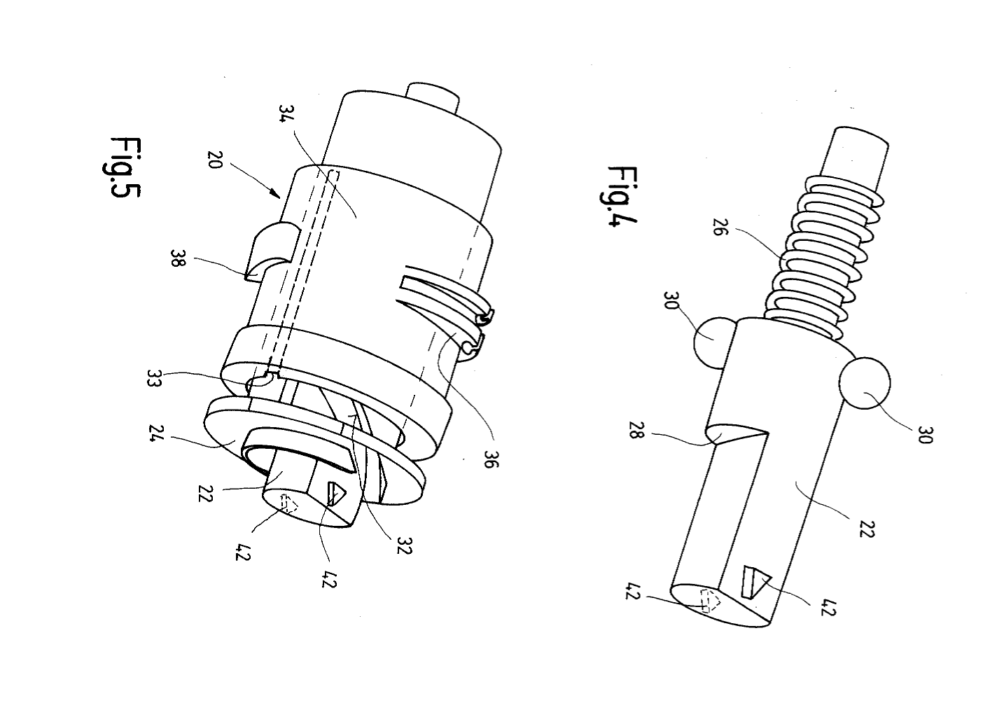

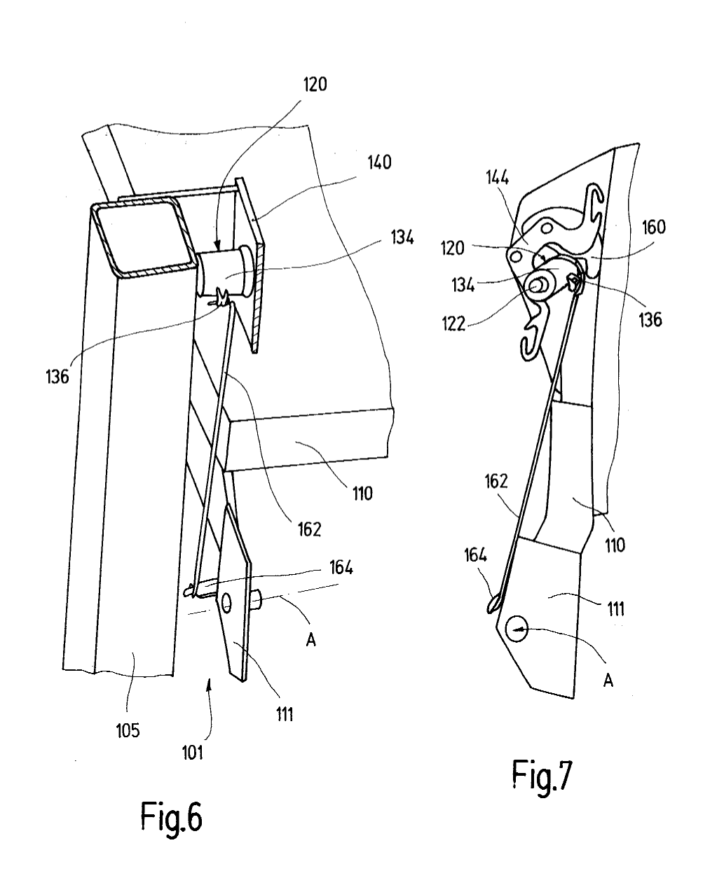

### DETAILED DESCRIPTION OF EXEMPLARY EMBODIMENTS

In the first exemplary embodiment, a vehicle seat 1 is designed as part of a divided rear seat installation for a motor vehicle. The vehicle seat 1 shown takes up approximately 40%+20% of the total width of the rear seat installation and is largely independent of a remaining 40% part of the rear seat installation. The vehicle seat 1 has a load-bearing structure, is upholstered (not shown) in a known manner and possesses head rests (not shown) and safety belts (not shown), although only the load-bearing structure is considered in the following.

A backrest structure 5 is pivotably and preferably inclinably attached and locked by way of fittings to the rear end (with respect to the typical direction of travel) of a preferably longitudinally adjustable and lowerable seat part structure 3 of the vehicle seat 1. The seat part structure 3, together with upholstery (not shown), defines a seat part of the vehicle seat 1. While the backrest structure 5 is only slightly narrower at its lower end than the seat part structure 3, the backrest structure 5 takes up only approximately 40% of the total width the seat part structure 3 at its upper end where—together with upholstery (not shown)—it defines a backrest. The other 20% of the total width is taken up by a flap structure 10 which—together with upholstery (not shown)—defines a flap. The flap structure 10 is arranged above the lower end of the backrest structure 5, and is laterally supported on either side in a pivotable fashion around a pivoting axis A on bearing plates 11 of the backrest structure 5. The flap structure 10 is locked, in a releasable fashion, with the backrest structure 5 in a use position suitable for sitting purposes (e.g., suitable for having a user sit in the vehicle seat 1). The locking is by way of a locking device that is described below in more detail. The flap structure 10 can thus be pivoted forward relative to the backrest structure 5 in the direction of travel into a non-use position that is not suitable for sitting purposes, in the present case into a substantially horizontal table position, in order to allow through-loading, and the flap structure 10 is carried along when the backrest structure 5 is pivoted. The pivoting axis A of the flap structure 10 and the pivoting axis of the backrest structure 5 are preferably located close to one another and, if applicable, are aligned with one another.

On the backrest structure 5, the locking device between the flap structure 10 and the backrest structure 5 is provided with a locking plate 15 having a latch opening 17 (e.g., locking element). The locking plate 15 is, for example, rigidly welded to a backrest strut facing the flap structure 10 or it is firmly attached elsewhere to the backrest structure 5. The latch opening 17 may also be directly formed in the backrest strut.

As a counterpart to the locking plate 15/latch opening 17, a rotating-sliding latch unit 20, which is for the most part already known from DE 199 53 686 C1, is arranged on (e.g., attached to) the flap structure 10. The entire disclosure of DE 199 53 686 C1 is incorporated herein by reference. In the rotating-sliding latch unit 20, an approximately cylindrical latch pin 22 is provided. The latch pin 22 is arranged so as to be axially slidable and circumferentially rotatable in a pot-like slotted link bushing 24. The latch pin 22 is supported on the bottom of the slotted link bushing 24 by way of a pressure spring 26 and is axially pretensioned against the slotted link bushing 24 in the outward direction. A shoulder 28 of the latch pin 22 is normally held more or less flush with the end-face edge of the slotted link bushing 24. Two ball bearings 30 arranged radially in depressions on the latch pin 22 each extend outward through a thread-shaped slotted link 32 of the slotted link bushing 24 into two longitudinal grooves 33 on the inner wall of a trigger sleeve 34 enclosing the slotted link bushing 24. The trigger sleeve 34 has an attachment bracket 36 and, offset thereto in the circumferential direction, a stop lug 38. By rotating the trigger sleeve 34, the ball bearings 30 are carried along in the circumferential direction by the wall of the longitudinal grooves 33. Because of the slotted links 32, the ball bearings 30 additionally slide in an axial direction in the longitudinal grooves 33. When the ball bearings 30 move, the latch pin 22—acting against the force of the pressure spring 26—is drawn axially inward (retracted) and at the same time rotated, the two superimposed movements producing a screw-like movement.

The rotating-sliding latch unit 20 is arranged between the flap structure 10, in particular a strut thereof, and a plate 40 located at a distance from the flap structure 10. The approximately rectangular flat plate 40 is firmly attached to the flap structure 10 by way of lateral straps or similar structures. The slotted link bushing 24 is attached in a rotationally fixed manner to the plate 40. The plate 40 has an opening for the latch pin 22 to pass through. When the flap structure 10 is locked with the backrest structure 5, the latch pin 22 also enters into the latch opening 17. As additional security, two radially opposed securing lugs 42 are provided at the outer end of the latch pin 22; when the latch pin 22 enters the latch opening 17, the securing lugs 42 pass through two radial recesses 43 on the edge of the latch opening 17, and then, due to the subsequent rotation of the latch pin 22 in the circumferential direction, they come to rest behind a part of the edge of the latch opening 17 that is adjacent to the recess 43 but itself has no recess. In so doing, the securing lugs 42 increase the local diameter of the latch pin 22 in such a way that it is greater than the diameter of the latch opening 17 (without the recesses 43).

In order to actuate the rotating-sliding latch unit 20 and thus to unlock the flap structure 10, a release lever 44 arranged on the inner side of the plate 40 is pivotably attached to the plate 40. The release lever 44 can be pivoted parallel to the plane of the plate 40 and has two arms for the respective attachment of loops or Bowden cables. At a right angle to the plate 40, an attachment arm 46 extends from the release lever 44, and one end of a Bowden cable 48 is attached to the attachment arm 46 while the other end of the cable is attached to the attachment bracket 36 of the rotating-sliding latch unit 20. By pivoting the release lever 44, the trigger sleeve 34 of the rotating-sliding latch unit 20 is rotated and thereby the latch pin is 22 retracted.

In order to maintain the rotating-sliding latch unit 20 in the actuated state, and thus to keep the latch pin 22 in the retracted position, without pulling on the release lever 44, a guide arm 50 is pivotably linked to the plate 40, and a locking lever 52 is in turn linked to the guide arm 50. The two-armed locking lever 52 is pretensioned against the plate 40 by way of a locking spring 54, and this pretension causes an upper arm 56 to bear against the trigger sleeve 34, normally in the area between the stop lug 38 and the attachment bracket 36. When the trigger sleeve 34 is rotated, the locking lever 52 comes to bear against the back of the stop lug 38 and snaps in behind it. The trigger sleeve 34 is now locked by the locking lever 52 positively engaged behind the stop lug 38, and the latch pin 22 remains retracted.

The flap structure 10 can now be pivoted forward relative to the backrest structure 5, from the use position into the non-use position. In so doing, the lower arm 58 of the locking lever 52 first slides along the upper edge of the bearing plate 11 that exists on this side, until, after leaving the bearing plate 11, the locking spring 54 brings the locking lever 52 and the guide arm 50 into a more extended position relative to each other. The components remain in their relative positions to each other as long as the flap structure 10 remains in the non-use position. Because the latch pin 22 is retracted, there is no risk of it causing injury.

When the flap structure 10 is pivoted back into the use position, the locking lever 52—because it is more stretched relative to the guide arm 50—comes to bear with its lower arm 58 against the front edge of the bearing plate 11. At the end of the pivoting movement of the flap structure 10, the locking lever 52 is pivoted towards the bearing plate 11 by the relative movement, thereby releasing the stop lug 38. The pressure spring 26 then again extends the latch pin 22, so that the latch pin 22 can engage in the latch opening 17 when the use position is reached. Preferably, the temporal and spatial coordination should be selected in such a way that the latch pin 22 first comes to bear with its end face against the latch plate 15, then the latch pin 22 slides along the latch plate 15 until it reaches and engages in the latch opening 17. The flap structure 10 is now once again locked with the backrest structure 5.

The second exemplary embodiment is similar to the first exemplary embodiment, unless otherwise described below, and for that reason identical components or components with identical functions bear reference numbers raised by 100.

The vehicle seat 101 of the second exemplary embodiment also comprises a backrest structure 105 and a flap structure 110 which is pivotably linked to bearing plates 111 of the backrest structure around a pivoting axis A. In the second exemplary embodiment, the rotating-sliding latch unit 120, with the plate 140, is attached to a strut of the backrest structure 105; and a pivotable pawl 160 (e.g., locking element) is provided on the flap structure 110 for cooperation with the latch pin 122. Regarding the latch pin 122, only the functionally less important end facing the backrest structure 105 is visible in the drawing. The pawl 160 is a known type of pawl mechanism. In the second exemplary embodiment, the pawl 160 is pivotably attached to the release lever 144. As an axial securing element, the latch pin 122 preferably has a radially extending collar that engages behind the pawl 160. A pulling means 162 (e.g., pulling mechanism), in the second exemplary embodiment a wire, is attached with one end to the attachment bracket 136 of the trigger sleeve 134 and the other end is attached to a pulling arm 164 on the flap structure 110. The pulling arm 164, which projects laterally from the flap structure 110, is located close to the pivoting axis A and in front of the pivoting axis A in the direction of travel.

In order to be able to pivot the flap structure 110 forward from the use position relative to the backrest structure 105, the pawl 160 is pivoted by way of the release lever 144, so that the latch pin 122 is released and the flap structure 110 is unlocked. When the flap structure 110 is pivoted, the downward-pivoting pulling arm 164, by way of the pulling means 162, pulls on the trigger sleeve 134 which, as it rotates, retracts the latch pin 122. Once the flap structure 110 has reached the non-use position, the latch pin 122 is completely retracted, so that there is no risk of injury.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. A vehicle seat, comprising:
a seat structure;
a backrest structure;
a flap structure mounted for being pivoted relative to the backrest structure from a use position to a non-use position; and
a rotating-sliding latch unit for releasably locking the flap structure to the backrest structure in the use position, wherein
the rotating-sliding latch unit includes a latch pin,
the latch pin is extended in the use position, and
the latch pin remains retracted in the non-use position.

2. The vehicle seat according to claim 1, wherein:
the rotating-sliding latch unit is attached to a first structure selected from the group consisting of the flap structure and the backrest structure,
the latch pin cooperates with a locking element for releasably locking the flap structure to the backrest structure in the use position,
the locking element is selected from the group consisting of a latch opening and a pawl,
the locking element is on a second structure selected from the group consisting of the flap structure and the backrest structure, and
the second structure is opposite from the rotating-sliding latch unit.

3. The vehicle seat according to claim 2, wherein the latch pin has an axially effective securing element for engaging behind a portion of the locking element while the flap structure is locked to the backrest structure in the use position.

4. The vehicle seat according to claim 1, wherein the rotating-sliding latch unit includes:
at least one spring adapted so that latch pin extends in response to force supplied by the spring; and
a rotatable trigger sleeve adapted so that the latch pin retracts when the trigger sleeve is rotated.

5. The vehicle seat according to claim 4, comprising a locking lever for blocking rotation of the trigger sleeve.

6. The vehicle seat according to claim 5, wherein:
the trigger sleeve includes a stop lug,
the locking lever is spring-loaded, and
when the flap structure is unlocked, the spring-loaded locking lever comes to bear against the back of the stop lug of the rotating trigger sleeve and then positively engages behind the stop lug to block rotation of the trigger sleeve.

7. The vehicle seat according to claim 5, wherein the locking lever is adapted for pivoting upwardly and releasing the trigger sleeve in response to the flap structure returning to the use position.

8. The vehicle seat according to claim 5, comprising a pivotably attached guide arm, wherein the locking lever is linked to the pivotably attached guide arm.

9. The vehicle seat according to claim 4, wherein:
the rotating-sliding latch unit has at least one ball bearing, and
the trigger sleeve acts upon the latch pin by way of the ball bearing.

10. The vehicle seat according to claim 2, comprising a pulling mechanism, wherein:
the rotating-sliding latch unit includes
(a) at least one spring adapted so that latch pin extends in response to force supplied by the spring, and
(b) a rotatable trigger sleeve adapted so that the latch pin retracts when the trigger sleeve is rotated,
a first end of the pulling mechanism is attached to the trigger sleeve, and
a second end of the pulling mechanism is attached to the second structure which is located opposite the rotating-sliding latch unit.

11. The vehicle seat according to claim 10, wherein the pulling mechanism is adapted to turn the trigger sleeve and thereby retract the latch pin in response to the flap structure pivoting forward.

12. The vehicle seat according to claim 2, wherein
the rotating-sliding latch unit includes
(a) at least one spring adapted so that latch pin extends in response to force supplied by the spring, and
(b) a rotatable trigger sleeve adapted so that the latch pin retracts when the trigger sleeve is rotated; and
the vehicle includes a locking lever adapted for selectively blocking rotation of the trigger sleeve.

13. The vehicle seat according to claim 3, wherein the axially effective securing element is selected from the group consisting of:
(a) at least one radially projecting securing lug that
(1) passes through a recess in the latch opening during locking, and
(2) engages behind an edge of the latch opening that is adjacent to the recess while the flap structure is locked to the backrest structure in the use position; and
(b) a collar that engages behind the pawl while the flap structure is locked to the backrest structure in the use position.

14. The vehicle seat according to claim 5, wherein locking lever is for cooperating with a stop lug on the trigger sleeve to block rotation of the trigger sleeve.

15. The vehicle seat according to claim 5, comprising a bearing plate, wherein the locking lever pivots upwardly and releases the trigger sleeve in response to the locking lever bearing against the bearing plate when the flap structure returns to the use position.

16. The vehicle seat according to claim 9, wherein:
the ball bearing is in
(a) a depression of a first component selected from the group consisting of the trigger sleeve and the latch pin, and
(b) a longitudinal groove of a second component selected from the group consisting of the trigger sleeve and the latch pin; and
the first component is one of the trigger sleeve and the latch pin, and the second component is the other of the trigger sleeve and the latch pin.

17. The vehicle seat according to claim 1, wherein:
the rotating-sliding latch unit is attached to the flap structure,
the latch pin cooperates with a latch opening for releasably locking the flap structure to the backrest structure in the use position, and
the latch opening is on the backrest structure.

18. The vehicle seat according to claim 17, wherein:
the rotating-sliding latch unit includes
(a) at least one spring adapted so that latch pin extends in response to force supplied by the spring, and
(b) a rotatable trigger sleeve adapted so that the latch pin retracts when the trigger sleeve is rotated; and
the vehicle seat includes a locking lever adapted for selectively blocking rotation of the trigger sleeve.

19. The vehicle seat according to claim 1, wherein:
the rotating-sliding latch unit is attached to the backrest structure,
the latch pin cooperates with a pawl for releasably locking the flap structure to the backrest structure in the use position, and
the pawl is mounted for moving with the flap structure.

20. The vehicle seat according to claim 19, comprising a pulling mechanism, wherein:
the rotating-sliding latch unit includes
(a) at least one spring adapted so that latch pin extends in response to force supplied by the spring, and
(b) a rotatable trigger sleeve adapted so that the latch pin retracts when the trigger sleeve is rotated, and
the pulling mechanism is adapted to turn the trigger sleeve and thereby retract the latch pin in response to the flap structure pivoting forward.
